(19) United States
(12) Patent Application Publication
(10) Pub. No.: US 2026/0300371 A1
(43) Pub. Date: Oct. 1, 2026

(54) ENHANCING A LARGE LANGUAGE MODEL WITH DOMAIN CONTEXT

(71) Applicant: INTERNATIONAL BUSINESS MACHINES CORPORATION, ARMONK, NY (US)

(72) Inventors: Declan Joyce, Gort (IE); IMRAN KHAN, Dublin (IE); Mansura Habiba, Jhonstown (IE); Rafflesia Khan, Dublin (IE)

(21) Appl. No.: 19/182,799

(22) Filed: Apr. 18, 2025

(30) Foreign Application Priority Data
Mar. 27, 2025 (GB) 2504525.3

(51) Int. Cl. G06F 16/36; G06F 40/30

(52) U.S. Cl. CPC G06F 16/367; G06F 40/30

(57) ABSTRACT

A method, computer program product, and computer system for enhancing a large language model (LLM) with domain context. The method includes: accessing a domain-specific ontology and generating a knowledge graph based on a domain-specific ontology of concepts and relationships; extracting ontological semantics and factors from the knowledge graph using a semantic query; enhancing an input prompt with the extracted ontological semantics and factors; generating key performance indicators and conditional parameters from the ontology; during training of the LLM, infusing the LLM with key performance indicators and conditional parameters; generating one or more infused input prompts based on the enhanced input prompt infused with the key performance indicators and conditional parameters for fine-tuning the LLM output to obtain a response; and comparing the response of the LLM against feedback.

### BACKGROUND

The present invention relates to large language models, and more specifically, to enhancing a large language model with domain context.

Large Language Models (LLMs) are designed to process and generate text based on patterns learned from vast amounts of data. LLMs can perform various tasks, including answering questions, developing creative content, summarizing text, and more. However, the ability of LLMs to “take decisions” comes with several important caveats, such as lack of real-world awareness, ethical and complex decision modelling, lack of specificity, risk of ambiguity, understanding of human insight and contexts, lack of dynamic data integration. LLMs cannot genuinely understand or prioritize these factors, as their outputs are derived from historical data patterns without an inherent sense and contextual insight.

Typical LLMs only learn the pattern and leverage parameters to understand the structure of input data as well as training data to generate content. An LLM requires different external systems to apply decision making capabilities. It is known for LLMs to use multiple models and multiple agents to enable the LLMs to make specific decisions for specific tasks through prompt engineering.

### SUMMARY

According to an aspect of the present invention there is provided a computer-implemented method for enhancing a large language model (LLM) with domain context, said method carried out by one or more processors of a computer system and comprising: accessing a domain-specific ontology and generating a knowledge graph based on a domain-specific ontology of concepts and relationships; extracting ontological semantics and factors from the knowledge graph using a semantic query; enhancing an input prompt with the extracted ontological semantics and factors; generating key performance indicators and conditional parameters from the ontology; during training of the LLM, infusing the LLM with semantically enhanced key performance indicators and conditional parameters; and generating one or more infused input prompts based on the enhanced input prompt infused with the key performance indicators and conditional parameters for fine-tuning the LLM output to obtain a response; and comparing the response of the LLM against feedback.

The method leverages, during training and post-training use of an LLM, fine tuning to infuse decision making attributes and KPI into the LLM. The method focuses on a knowledge domain and the key drivers for decision making in that knowledge domain.

External systems are not required to apply decision making capabilities, as the method learns the context of the input prompt along with the data structure of the knowledge graph and the different conditional drivers related to the input prompt for decision-making.

According to another aspect of the present invention there is provided a computer system comprising one or more processors, one or more memories, and one or more computer readable hardware storage devices, said one or more hardware storage devices containing program code executable by the one or more processors via the one or more memories to implement a method for enhancing a large language model (LLM) with domain context, said method comprising: a validator data processor for: accessing a domain-specific ontology and generating a knowledge graph based on a domain-specific ontology of concepts and relationships; and extracting ontological semantics and factors from the knowledge graph using a semantic query; a multi-agent prompt orchestrator for: enhancing an input prompt with the extracted ontological semantics and factors; generating key performance indicators and conditional parameters from the ontology; infusing the LLM with key performance indicators and conditional parameters during LLM training and generating one or more infused input prompts based on the enhanced input prompt infused with the key performance indicators and conditional parameters; inputting the one or more infused input prompts into the LLM and obtaining a response; and comparing the response of the LLM against feedback.

According to a further aspect of the present invention there is provided a computer program product for enhancing a large language model (LLM) with domain context, the computer program product comprising a computer readable storage medium having program instructions embodied therewith, the program instructions executable by a processor to cause the processor to: access a domain-specific ontology and generating a knowledge graph based on a domain-specific ontology of concepts and relationships; extract ontological semantics and factors from the knowledge graph using a semantic query; enhance an input prompt with the extracted ontological semantics and factors; generate key performance indicators and conditional parameters from the ontology; during training of the LLM, infuse the LLM with semantically enhanced key performance indicators and conditional parameters; generate one or more infused input prompts based on the enhanced input prompt infused with the key performance indicators and conditional parameters for fine-tuning the LLM output and obtaining a response; and compare the response of the LLM against feedback.

The computer readable storage medium may be a non-transitory computer readable storage medium and the computer readable program code may be executable by a processing circuit.

The present invention seeks to provide one or more concepts for providing domain enhanced prompts for training and post-training of LLMs. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor.

### BRIEF DESCRIPTION OF THE DRAWINGS

Embodiments of the present invention will now be described, by way of example only, with reference to the accompanying drawings:

FIG. 1 is a block diagram of an example embodiment of a system in accordance with embodiments of the present invention;

FIGS. 2A and 2B are flow diagrams of example embodiments of methods in accordance with embodiments of the present invention;

FIG. 3 is a block diagram including flow of an example embodiment of a system and method in accordance with embodiments of the present invention;

FIGS. 4A and 4B are block diagrams including flows of example embodiments of a system in accordance with embodiments of the present invention with FIG. 4A showing data and query flows and FIG. 4B showing contextual data flow; and

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for enhancing training of an LLM with domain context. The disclosure aims to provide the LLM with conditional decision-making capabilities in real-time by leveraging ontology and multi-agent communication and probabilistic algorithms.

Real-word awareness in a given domain is infused by employing multi-objective agents for enriching LLM prompt input data to contain conditional decision-making features and entities as part of the prompt input. The output is also validated against the target decision features and conditions. Conditional application of probabilistic algorithms may be used to assess the success rate or confidence level of the LLM's output to remove the risk of ambiguity.

Contextual and decision-controller data is infused using an ontological orchestration that populates a knowledge graph (KG) with structured data, creating nodes for entities and edges for relationships between them. This leverages the KG to enforce decision-making capabilities.

Real-time adaptive orchestration continuously evaluates and adjusts the output by leveraging self-prompting capability through an agent to enrich the output thereby integrating dynamic data.

The domain content enhancement of an LLM is an improvement in the technical field of artificial intelligence generally, in particular to improve accuracy of LLM output and decision-making in a given domain. The LLM may be applied to technical fields.

An artificial intelligence (AI) agent refers to a system or program that is capable of autonomously performing tasks on behalf of a user or another system by designing its workflow and utilizing available tools. These agents use the advanced natural language processing techniques of LLMs to comprehend and respond to user inputs step-by-step and determine when to call on external tools on the backend to obtain up-to-date information, optimize workflow and create subtasks autonomously to achieve complex goals. The agents are auxiliary agents that have functions relating to the LLM that is the subject of the domain content enhancement. The agents integrate the context from the ontology or knowledge domain. These agents can also be used to determine the decision path for any workflow based on the knowledge graph. The agents have specific functions, and they are trained against the knowledge domain.

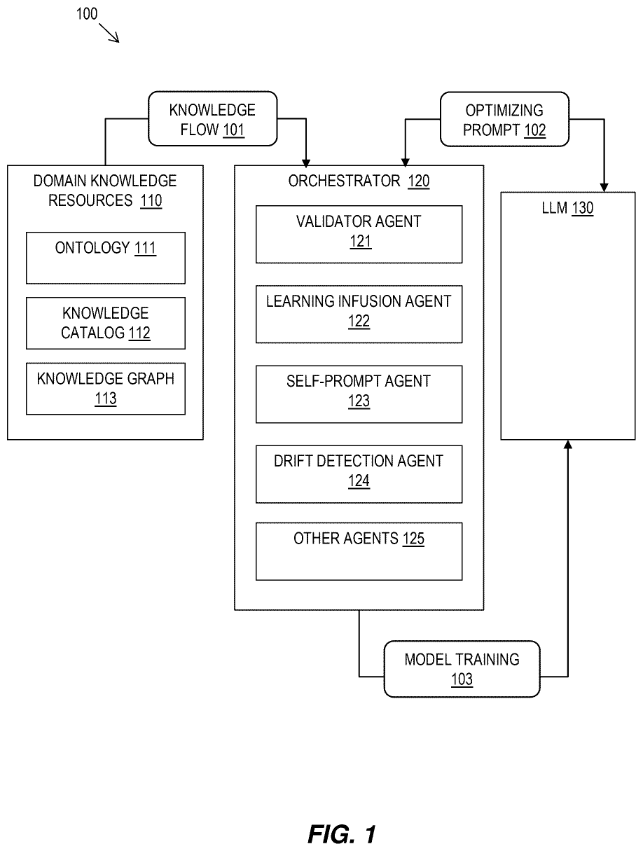

Referring to FIG. 1, a block diagram illustrates the described system 100. Domain knowledge resources 110 may be provided or accessed and may include an ontology 111, a knowledge catalogue 112, and a knowledge graph 113. A multi-agent orchestrator 120 is provided thar receives a knowledge flow 101 from the domain knowledge resources 110. A multi-agent orchestrator 120 optimizes prompt inputs 102 to an LLM 130 and receives responses for feedback. The orchestrator 120 also provides model training 103 of the LLM 130 to infuse the LLM 130 with domain knowledge.

The LLM 130 includes neural networks configured to learn semantic embeddings of the concepts represented in the ontology by mapping ontology concepts to continuous vector spaces to capture semantic relationships between concepts. The described system leverages the technique to make the decision data available in the embedding.

The multi-agent orchestrator 120 includes a validator agent 121 for validating the ontology and updating the ontology to improve quality. The validator agent 121 may be empowered by probabilistic algorithms and multi-agent capabilities to control embedding to infuse data dynamically and remove the risk of ambiguity. The validator agent 121 may validate the quality of the semantic query against any key performance factors and thresholds and/or may determine the success of an input prompt generated by a self-prompt agent.

The multi-agent orchestrator 120 includes a learning infusion agent 122 for improving the input prompt including the enhancing and infusing of the input prompt during training of the LLM and during prompt use. This infuses insight and real-world awareness into the input prompt using contextual and decision-controller data. The validator agent 121 and the learning infusing agent 122 may exchange scores for different input prompts to improve learning by the LLM.

The learning infusion agent 122 may use probabilistic algorithms (like the Monte Carlo model that uses repeated random sampling to solve problems) to help LLMs handle complex probabilistic reasoning in code by estimating the outcomes of different programming decisions or algorithmic paths. Also, by simulating different scenarios, Monte Carlo methods can improve decision-making in uncertain environments and can create different intermediate outputs.

The multi-agent orchestrator 120 may include a self-prompt agent 123 for generating an input prompt including real-time adaptive orchestration by continuously evaluating and adjusting the input prompt to enrich the output by comparing a response of the LLM against feedback. This is not just a query generator or prompt generator as it is influenced by contextual data and semantics to generate prompts that can evaluate the LLM's weakness against real-world awareness, certainty, specialized expertise, knowledge domain-based knowledge, and impact the decision-making.

The multi-agent orchestrator 120 may include a drift detection agent 124 for pattern recognition and asking questions. Probabilistic algorithms like Variational Inference (VI) can help tailor feedback and improve the quality of self-assessment prompts for the prompt agent. VI can also be used to identify areas where the LLM's knowledge is weakest, guiding the data collection process and data pipeline to determine that.

The multi-agent orchestrator 120 may include additional agents 125 for integrating dynamic data. The multiple agents may follow a collaborative learning mechanism.

The neuromyotonic artificial intelligent system may incorporate feedback loops to refine decision-making over time. As new data becomes available and decisions are made, the LLM 130 can update its neural network components through reinforcement learning or online learning while updating the ontology 111 based on new knowledge.

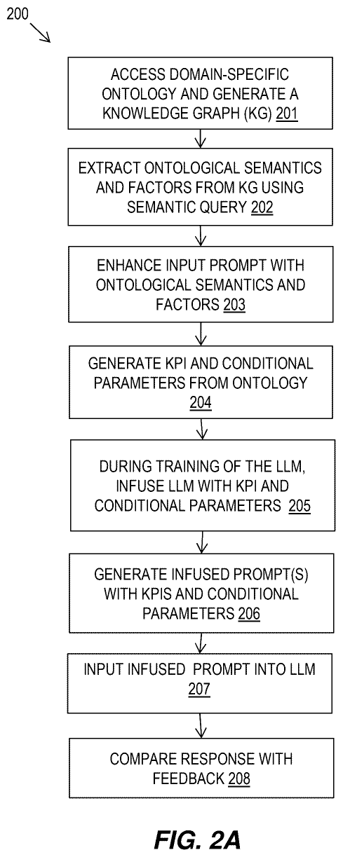

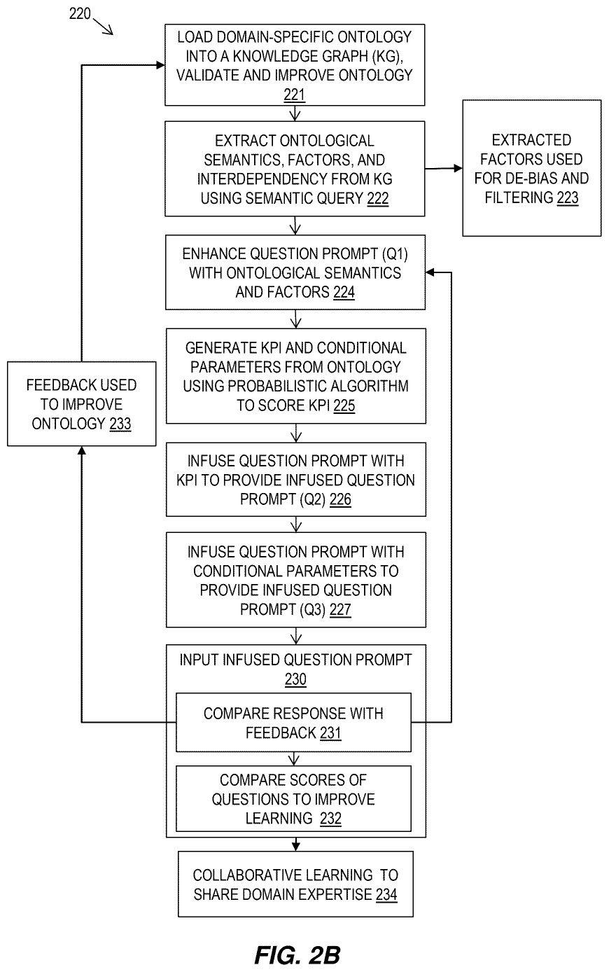

Referring to FIG. 2A, a flow diagram 200 shows an example embodiment of a computer-implemented method for enhancing a large language model (LLM) with domain context. The method may be carried out during training of the LLM and during post-training.

The method includes accessing 201 a domain-specific ontology and generating a knowledge graph based on a domain-specific ontology of concepts and relationships. The method extracts 202 ontological semantics and factors from the knowledge graph using a semantic query.

Ontological semantics refers to a structured approach to understanding, representing, and processing meaning based on a formal ontology—a structured framework of concepts and relationships. In the context of extracting ontological semantics and factors from a knowledge graph using a semantic query, ontological semantics plays a crucial role in defining and interpreting meaningful relationships between entities in a structured and machine-readable way.

In semantic queries, factors may be weighting parameters that determine the importance of certain relationships. For example, in a graph-based recommendation system, factors may include: Relevance Score (e.g., how closely two entities are related); or Popularity Score (e.g., how frequently a node is referenced). Factors can be used for ontological reasoning. A factor can refer to an inference rule or axiom that helps deduce relationships. For example: In an enterprise knowledge graph, factors influencing decision-making might be: Business Rules (e.g., “if customer revenue>$1M, classify as VIP”), Causal Relations (e.g., “Economic downturn→Reduced Sales”). The extracted factors may later be used for further filtering enhancement as described below.

The method enhances 203 an input prompt with the extracted ontological semantics and factors. The method generates 204 key performance indicators and conditional parameters from the ontology. Generating 204 key performance indicators and conditional parameters from the ontology may use a probabilistic algorithm for scoring the key performance indicators to identify their impact.

Key performance indicators (KPIs) are defined to ensure that the prompt aligns with predefined objectives such as accuracy, relevance, clarity, and contextual specificity or other KPIs. By incorporating KPIs, the method systematically adjusts the structure and content of the original prompt optimizing it to generate responses that better meet user requirements. Conditional parameters refer to rules or constraints that influence how data is retrieved, processed, or interpreted. These parameters determine when certain conditions must be met before a specific semantic relationship or factor is extracted.

During training 205 of the LLM, the method infuses the LLM with semantically enhanced key performance indicators and conditional parameters. The method generates 206 one or more infused input prompts for input 207 into the LLM and obtains a response. The method can repeat the prompt generation to further fine-tune the LLM output. The method compares 208 the response of the LLM against feedback which ensure re-enforcement learning for the model. The feedback may be user feedback or self-generated feedback relating to target decision features and conditions.

Conditional application of probabilistic algorithms may be used to assess the success rate or confidence level of the LLM's output to remove ambiguity. Probabilistic algorithms are used that calculate scores that are based upon weights that are associated with values for specific attributes.

The method may repeat the input prompt enhancing and infusing to improve the response against the feedback.

The method may include inputting the input prompt into a pre-ontology trained LLM and obtaining an initial response and comparing the response obtained by the infused input prompt with the initial response to assess coverage of the key performance indicators and the conditional parameters.

The knowledge infusing to the LLM happens in different ways. Knowledge infusion occurs during data extraction by extracting different KPIs and conditional parameters that are embedded in the vector data. Knowledge infusion occurs during LLM training through infusing domain knowledge, KPIs and conditional parameters into the LLM. Knowledge infusion occurs by leveraging infused prompts.

Referring to FIG. 2B, a flow diagram 220 shows a more detailed example embodiment of the described method.

The method may load 221 a domain-specific ontology (for example, Web Ontology Language (OWL)) into a knowledge graph (KG). This may provide contextual and decision-controller data. The validator agent may validate some or all of the ontological class, factors, properties, relation, and interdependencies in the OWL and update the domain-specific ontology to improve the quality.

The method may extract 222 ontological semantics, factors (F), and interdependency from the KG using a semantic query. Factors extracted in step 222 may be used for further enhancement 223, such as de-bias and another filtering mechanisms.

The method may enhance 224 a question prompt (Q1) with ontological semantics and factors (F) generated in step 222. The learning infusion agent may perform this action to improve the prompt.

The method may generate 225 KPI and conditional parameters from the domain-specific ontology. Probabilistic algorithms may score different KPI and identify their corresponding impact on the decision to improve the strength of the LLM outputs.

The method may infuse 226 the enhanced prompt using KPI, which will generate an infused prompt (Q2). This may infuse contextual and decision-controller data. The learning infusion agent may perform this action to improve the prompt. The method involves infusing a base input prompt by infusing it with specific KPIs to create a more refined and targeted version, referred to as the infused prompt (Q2). This method ensures that the prompt aligns with predefined objectives such as accuracy, relevance, clarity, and contextual specificity or other KPIs. By incorporating KPIs, the method systematically adjusts the structure and content of the original prompt optimizing it to generate responses that better meet user requirements. For instance, if the original prompt is vague or lacks constraints, the infusion process may introduce parameters that improve precision, enforce length restrictions, or guide the AI toward producing output that aligns with a specific domain or use case. As a result, the infused prompt becomes more effective in eliciting high-quality responses from an AI model, making it a critical step in enhancing AI-driven communication and decision-making.

The method may infuse 227 the question prompt using conditional parameters, which will generate an infused prompt (Q3). This may remove the risk for ambiguity. The learning infusion agent may perform this action to improve the prompt.

The method may input 230 the infused question prompt by asking the LLM the infused prompt (Q3) for a better response (R). The self-prompt agent may compare 231 the response (R) of Q3 with either user feedback or self-generated feedback. The method may repeat steps 224 to 230 to improve the response R to be more decisive.

The validator agent and learning infusion agent may compare 232 scores for different questions to improve the learning. This mutual multi-agent communication improves the quality of decision and conditional data. The knowledge and learning from learning infusion agent may be shared with other additional agents such as the drift detection agent. Agents may follow 234 any collaborating learning mechanism, such as the SWAM intelligence mechanism, to share contextual, conditional, bias, decision metrics, and other knowledge and domain expertise. The feedback may help to improve 233 the ontology as well as the knowledge graph.

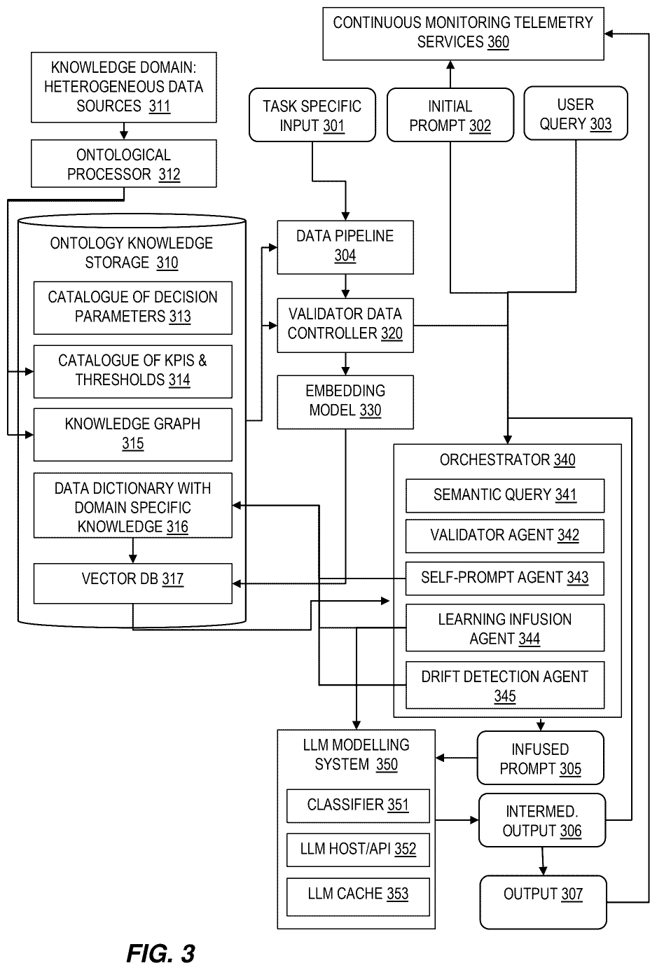

Referring to FIG. 3, a block diagram shows an example embodiment of the described system for providing and enhanced domain-trained LLM. The system may be provided on one or more computing devices that may include at least one processor, a hardware module, or a circuit for executing the functions of the described components which may be software units executing on the at least one processor. Multiple processors running parallel processing threads may be provided enabling parallel processing of some or all of the functions of the components. Memory may be configured to provide computer instructions to the at least one processor to carry out the functionality of the system components.

An ontology knowledge storage 310 is provided that is controlled by an ontological processor 312 that filters data and orchestrates the ontology knowledge storage 310. The ontology processor 312 may obtain data for a knowledge domain from heterogeneous data sources 311. The ontology knowledge storage 310 includes catalogues including a catalogue of decision parameters 313 and a catalogue of KPIs and thresholds 314. The ontology knowledge storage 310 includes a knowledge graph 315 for structuring the ontology data into concepts and relationships. The ontology knowledge storage 310 includes a data dictionary 316 with domain specific knowledge and expertise. The ontology knowledge storage 310 includes a vector database 317 that is infused with domain-specific knowledge and provides a decision matrix.

A validator data controller 320 is provided as part of the pipeline and is empowered by probabilistic algorithms and has capabilities for controlled embedding to infuse data dynamically in an embedding model 330. The embedding model 330 may be empowered by semantic embedding. The validator data controller 320 provides controlled data from the domain knowledge storage 310 for input to the multi-agent orchestrator 340. The controlled data is embedded with contextual data as well as decision parameters.

The multi-agent orchestrator 340 includes a validator agent 342, a self-prompt agent 343, a learning infusion agent 344, and optionally a drift detection agent 345 and other agents. The agents of the orchestrator may be as described in relation to FIG. 1. The orchestrator 340 receives a semantic query 341 for processing by the agents.

An LLM modeling system 350 is provided including an LLM host/API 352, an LLM cache 353, and a classifier 351. The LLM cache 353 stores the LLM outputs. The LLM classifier 352 scans output for harmful or offensive content. The LLM is trained on contextual parameters and contextual data of the domain so that it can make decisions whilst generating content. The LLM is integrated with the knowledge graph 315 and a probabilistic algorithm using the drift detection agent 345 can increase the influence of the decision matrix stored in the knowledge graph and the success rate for the content of a task as the LLM learns context. Any existing LLM may be trained using the proposed system. LLMs are capable of performing self-promotion on themselves.

The inputs into the system include a task specific input 301 into a data pipeline 304 that ensures controlled and filtered dynamic data ingestion for the prompt and others. The data pipeline 304 also receives input from the catalogues of the ontology knowledge storage 310.

An initial prompt 302 and/or user query 303 are input into the orchestrator 340 which also receives controlled data embedded with contextual data and decision parameters from the validator data controller 320. The orchestrator 340 receives input from the vector database 317 and outputs data back to the data dictionary 316. The orchestrator 340 outputs an infused prompt 305 to the LLM modeling system 350 that provides an intermediate output 306 that is validated and provided in a feedback loop to the orchestrator 340 then provides a final output 307 response of the LLM.

Continuous monitoring telemetry services 360 may be provided for monitoring the data pipeline, the input prompt and the LLM output.

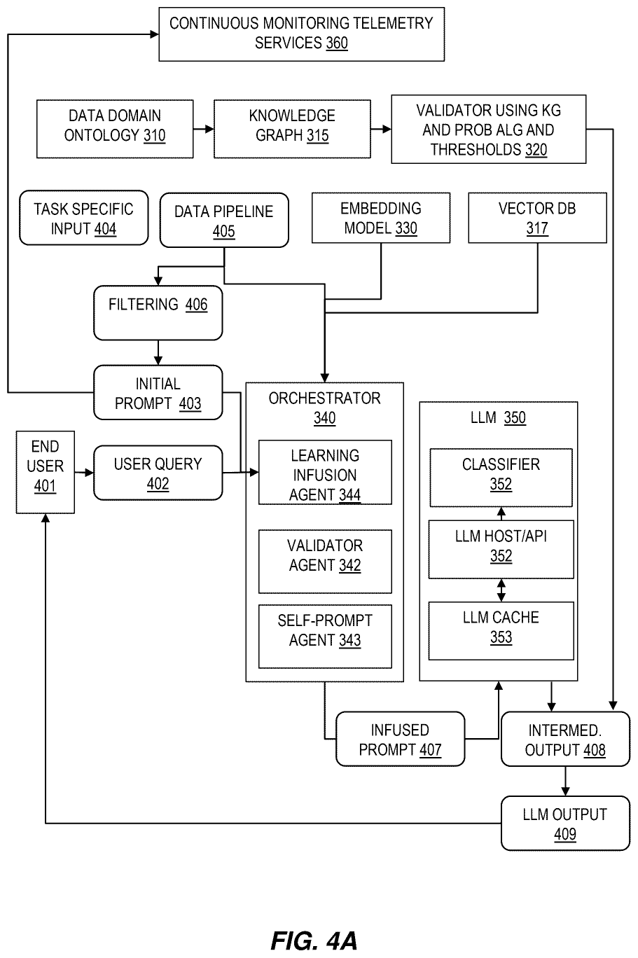

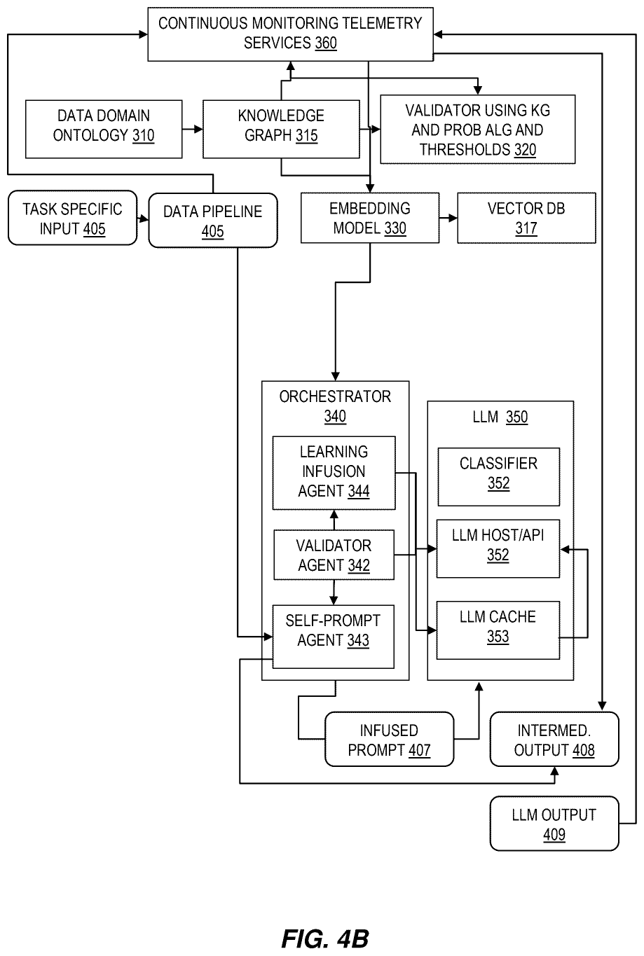

Referring to FIGS. 4A and 4B, block diagrams show the flow through the components described in the system of FIG. 3 with the components having the same reference numbers as FIG. 3. FIG. 4A shows the data flow and query flow and FIG. 4B shows the contextual data flow.

Referring to FIG. 4A, the data flow and query flow of this example includes an end user 401 providing a user query 402 that is input to the learning infusion agent 344 of the orchestrator 340. An initial prompt 403 is also input to the learning infusion agent 344 and also feeds back to the continuous monitoring telemetry services 360. The initial prompt 403 receives task specific input 404 via the data pipeline 405 that is filtered 406 to extract context snippets that are injected into the initial prompt 403. The data pipeline 405 also feeds data to the orchestrator 340. The data pipeline 405 also provides filtered data (for unauthorized data) to the embedding model 330.

The LLM 350 receives an infused prompt 407 from the orchestrator 340 and outputs an intermediate output 408 that provides feedback and is validated by the validator 320 before a final LLM output 409 is returned to the end user 401.

Referring to FIG. 4B, the contextual data flow is shown. Contextual data flows from the task specific input 404 via the data pipeline 405 to the self-prompt agent 343 of the orchestrator 340 and within the agents in the orchestrator 340. The orchestrator 340 provides an infused prompt 407 that includes contextual data to the LLM 350. The self-prompt agent 343 feeds contextual data to the intermediate output 408.

From the orchestrator 340, the validator agent 342 and the learning infusion agent 344 provide contextual data flow to the LLM host/API 352 and the LLM cache 353. The LLM cache 353 provides contextual data flow of outputs to the LLM host/API 352.

Contextual data flows from the continuous monitoring telemetry services 360 to the validator 320 and to the embedding model 330. The contextual data flows from the knowledge graph 315 to the embedding model 330 and to the continuous monitoring telemetry services 360. The contextual data flows from the embedding model 330 to the vector database 317. Contextual data flows from the continuous monitoring telemetry services 360 to the intermediate output 408 to be incorporated into the feedback.

The contextual data flow leverages during training and post-training fine tuning to infuse the decision-making attributes and KPI into the LLM. A specific knowledge domain is focused on and the key drivers for decision making in that knowledge domain are identified. The method is focused at the knowledge domain level so the decision making for the task does not become biased and narrowly focused which often is not useful.

The method focuses on KPIs for any domain specific decision making. For example, in the example implementation given below, a suitable cloud for an application deployment pattern is to be selected. The LLM is focused using cost, performance, ease of maintenance, and other KPIs that are widely used to make decisions for cloud domains. Any human being would use similar KPI to make the decisions. As the described method is a more rational approach, it is not dependent on human computer interaction (HCl).

The LLM input data is influenced with different parameters and features to include the data related to context and the domain. Therefore, the LLM not only learns the underlying complex structure and pattern of the input data, but it also learns the contextual parameters, the differences between different domains, interoperability, and internal relationship for the same or similar input data by leveraging conditional data from a pre-defined knowledge graph.

The conditional features from the knowledge graph are processed along with input, so the LLMs are trained on the training data along with decision-making conditional data so the capability to make certain decisions is embedded in the LLM models, and it does not need an external system or additional human interaction to fine-tune the content for a certain context. The described method uses a single LLM and trains it on conditional data so it can make decisions without additional communication with multiple agents and external systems and further prompt engineering.

Decision-making capabilities are integrated into an LLM model training. Re-enforcement learning and probabilistic algorithm-based techniques are used for self-assessment. Autonomous learning capabilities are used to self-tune and prompted over time via reinforcement learning. Real-time data integration is provided for decision-making capabilities by integrating input data validation and their relationship with the target decision domain. Domain knowledge is infused and specialized learning is provided in the LLM to remove bias as well as ambiguity.

### Worked Example—Suitable Cloud Selection for an Application Deployment Pattern

Step 1: Generate an ontology for a cloud service provider domain. This includes the following steps:
Create ontology and populate it;
   Create instances of cloud service providers;
   Create instances of factors;
   Assign factors to cloud service providers;
   Define project type suitability;
   Save ontology to a file;
   Verify that the ontology was saved correctly;
   Load the ontology for verification;
   Print the ontology entities for verification;
   Print details of individuals;
   Load the ontology into an RDF graph;
   Load the embedded vector form of the RDF graph in the database;
   Print all triples in the graph to verify the data;
   Count the number of triples;
   Define the SPARQL query to extract factors;
   Execute the query;
   Check if results factors is not empty.
   Step 2: Leverage any LLM form prompt engineering. This may import pipeline from transformers. The selected LLM is then trained using the extracted factors. Once the model is trained, the LLM is now infused with additional domain specific knowledge.
   Step 3: Ask the original query to the pre-trained language model and get the response.

Original prompt—“What are the key factors to consider when choosing between AWS, Google Cloud, and Azure for deploying an AI platform, and which service is most suitable for a large-scale machine learning project?”

Step 4: Load the ontology and extract semantics from the prompt/question.

Step 5: Update the prompt based on semantics:

Updated prompt with KPI—“What are the key factors to consider when choosing between AWS, Google Cloud, and Azure for deploying an AI platform, and which service is most suitable for a large-scale machine learning project? Specifically, consider the following factors for each service: AWS (Cost, Scalability, EaseOfUse, AITools, Support, Integrations), Google Cloud (Cost, Scalability, EaseOfUse, AITools, Support, Integrations), and Azure (Cost, Scalability, EaseOfUse, AITools, Support, Integrations).”

Step 5: Enhance the prompt using KPI and conditional parameters. This includes the following:

Define KPIs and conditional parameters to include in the question:
kpis=[“performance”, “cost efficiency”, “scalability”, “ease of integration”, “support quality”]
conditional_parameters=[“region availability”, “compliance requirements”, “service level agreements (SLAs)”]
Function to enhance the question with KPIs and conditional parameters;
Generate and print the enhanced question;
Example usage with initial question and factors;
Extracted factors for each cloud service provider;
Function to generate the updated question using the extracted factors;
Generate the updated question;
Generate the enhanced question with more context and decision elements.

Enhanced Questions With KPI—“What are the key factors to consider when choosing between AWS, Google Cloud, and Azure for deploying an AI platform, and which service is most suitable for a large-scale machine learning project? Additionally, evaluate each service based on these key performance indicators: performance, cost efficiency, scalability, ease of integration, support quality. Furthermore, consider conditional parameters such as region availability, compliance requirements, service level agreements (SLAs) when making the decision.

Enhanced Questions with factors—“What are the key factors to consider when choosing between AWS, Google Cloud, and Azure for deploying an AI platform, and which service is most suitable for a large-scale machine learning project? Specifically, consider the following factors for each service: AWS (Cost, Scalability, EaseOfUse, AITools, Support, Integrations), Google Cloud (Cost, Scalability, EaseOfUse, AITools, Support, Integrations), and Azure (Cost, Scalability, EaseOfUse, AITools, Support, Integrations). Additionally, evaluate each service based on these key performance indicators: performance, cost efficiency, scalability, ease of integration, support quality. Furthermore, consider conditional parameters such as region availability, compliance requirements, service level agreements (SLAs) when making the decision.

Step 7: Ask the updated prompt to an open-source LLM and get the enhanced response.

Step 8—Compare the enhanced response against to original response and assess coverage of KPIs and conditional parameters.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

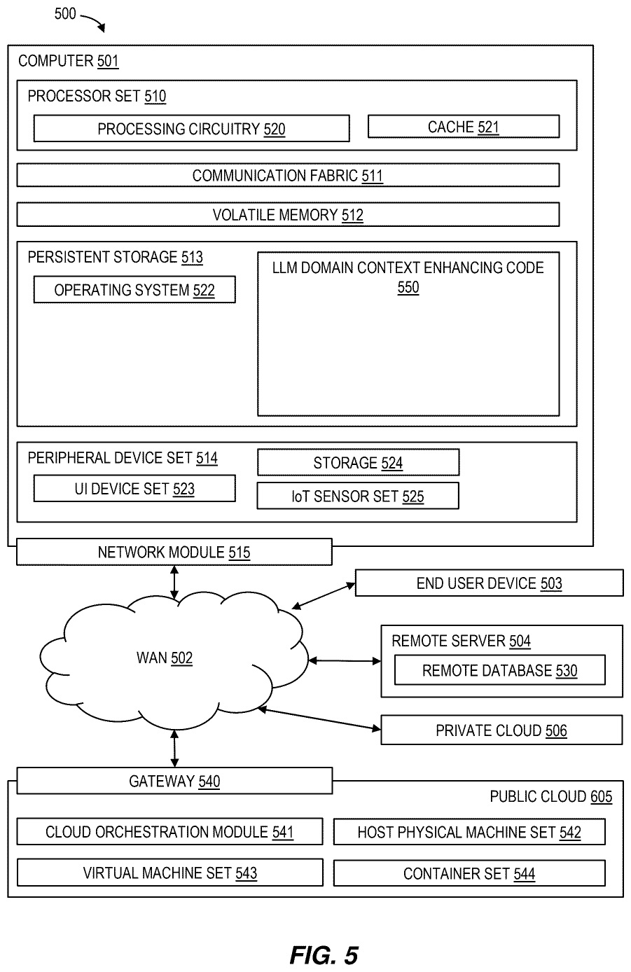

Referring to FIG. 5, computing environment 500 contains an example of an environment for the execution of at least some of the computer code involved in performing the inventive methods, such as LLM domain context enhancing 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

1. A computer-implemented method for enhancing a large language model (LLM) with domain context, said method carried out by one or more processors of a computer system and comprising:
accessing a domain-specific ontology and generating a knowledge graph based on a domain-specific ontology of concepts and relationships;
extracting ontological semantics and factors from the knowledge graph using a semantic query;
enhancing an input prompt with the extracted ontological semantics and factors;
generating key performance indicators and conditional parameters from the ontology;
during training of the LLM, infusing the LLM with semantically enhanced key performance indicators and conditional parameters;
generating one or more infused input prompts based on the enhanced input prompt infused with the key performance indicators and conditional parameters for fine-tuning an LLM output to obtain a response; and
comparing the response of the LLM against feedback.

2. The method of claim 1, including repeating the input prompt enhancing and infusing to improve the response against the feedback.

3. The method of claim 1, wherein generating key performance indicators and conditional parameters from the ontology uses a probabilistic algorithm for scoring the key performance indicators to identify their impact.

4. The method of claim 1, including:
inputting the input prompt into a pre-ontology trained LLM and obtaining an initial response; and
comparing the response obtained by the infused input prompt with the initial response to assess coverage of the key performance indicators and the conditional parameters.

5. The method of claim 1, wherein the feedback is user feedback or self-generated feedback relating to target decision features and conditions.

6. The method of claim 1, wherein the extracted factors are used for further filtering enhancement.

7. The method of claim 1, wherein the LLM includes neural networks configured to learn semantic embeddings of the concepts in the ontology by mapping ontology concepts to continuous vector spaces to capture semantic relationships between concepts.

8. The method of claim 1, wherein the method is carried out during training of the LLM and during post-training.

9. The method of claim 1, including conditional application of probabilistic algorithms to assess a success rate or a confidence level of the LLM output to remove ambiguity.

10. The method of claim 1, wherein generating a knowledge graph based on a domain-specific ontology of concepts and relationships populates the knowledge graph with structured data, creating nodes for concepts and edges for relationships between them, wherein the relationship are inputs to a decision matrix to provide decision-making capabilities.

11. The method of claim 1, including using a multiple agent arrangement for enhancing prompt orchestration including:
a learning infusing agent for improving the input prompt including the enhancing and infusing of the input prompt during training and through prompt use;
a self-prompt agent for generating an input prompt including real-time adaptive orchestration by continuously evaluating and adjusting the input prompt to enrich the output by comparing a response of the LLM against feedback; and
a validator agent for validating the ontology and updating the ontology to improve quality.

12. The method of claim 11, wherein the validator agent is for validating the quality of the semantic query against any key performance factors and thresholds and/or determining a success of an input prompt generated by the self-prompt agent.

13. The method of claim 11, wherein the validator agent and the learning infusing agent exchange scores for different input prompts to improve learning by the LLM.

14. The method of claim 11, wherein the multiple agents follow a collaborative learning mechanism.

15. A computer system comprising one or more processors, one or more memories, and one or more computer readable hardware storage devices, said one or more hardware storage devices containing program code executable by the one or more processors via the one or more memories to implement a method for enhancing a large language model (LLM) with domain context, said method comprising:
a validator data processor for:
accessing a domain-specific ontology and generating a knowledge graph based on a domain-specific ontology of concepts and relationships; and
extracting ontological semantics and factors from the knowledge graph using a semantic query;
a multi-agent prompt orchestrator for:
enhancing an input prompt with the extracted ontological semantics and factors;
generating key performance indicators and conditional parameters from the ontology;
infusing the LLM with key performance indicators and conditional parameters during LLM training and generating one or more infused input prompts based on the enhanced input prompt infused with the key performance indicators and conditional parameters;
inputting the one or more infused input prompts into the LLM and obtaining a response; and
comparing the response of the LLM against feedback.

16. The system of claim 15, wherein the multi-agent prompt orchestrator includes:
a learning infusing agent for improving the input prompt including the enhancing and infusing of the input prompt during training and through prompt use;
a self-prompt agent for generating an input prompt including real-time adaptive orchestration by continuously evaluating and adjusting an output prompt to enrich the output by comparing a response of the LLM against feedback; and
a validator agent for validating the ontology and updating the ontology to improve quality.

17. The system of claim 16, wherein the validator agent is for validating the quality of the semantic query against any key performance factors and thresholds and/or determining a success of an input prompt generated by the self-prompt agent.

18. The system of claim 16, wherein the validator agent and the learning infusing agent exchange scores for different input prompts to improve learning by the LLM.

19. The system of claim 15, further including:
a drift detection agent for pattern recognition and asking questions employing probabilistic algorithms.

20. A computer program product for enhancing a large language model (LLM) with domain context, the computer program product comprising a computer readable storage medium having program instructions embodied therewith, the program instructions executable by a processor to cause the processor to:
access a domain-specific ontology and generating a knowledge graph based on a domain-specific ontology of concepts and relationships;
extract ontological semantics and factors from the knowledge graph using a semantic query;
enhance an input prompt with the extracted ontological semantics and factors;
generate key performance indicators and conditional parameters from the ontology;
during training of the LLM, infuse the LLM with key performance indicators and conditional parameters;
generate one or more infused input prompts for based on the enhanced input prompt infused with the key performance indicators and conditional parameters for fine-tuning an LLM output to obtain a response; and
compare the response of the LLM against feedback.
